(19) United States
(12) Patent Application Publication
(10) Pub. No.: US 2018/0285137 A1
(43) Pub. Date: Oct. 4, 2018

(54) METHOD AND DEVICE FOR MIGRATING VIRTUAL MACHINES

(71) Applicant: NANNING FUGUI PRECISION INDUSTRIAL CO., LTD., Nanning (CN)

(72) Inventors: CHIEN-PAN LAI, New Taipei (TW); CHIH-YUAN HUANG, New Taipei (TW)

(21) Appl. No.: 15/498,475

(22) Filed: Apr. 27, 2017

(30) Foreign Application Priority Data
Mar. 31, 2017 (TW) 106111158

(51) Int. Cl. G06F 9/455

(52) U.S. Cl. CPC G06F 9/45558; G06F 2009/45579; G06F 2009/4557

(57) ABSTRACT

A method for migrating a virtual machine running in a first physical machine to avoid overloading of the first physical machine and an input/output (I/O) unit determines respective statuses of the first physical machine and the first input/output (I/O) unit configured as a transmission interface of the virtual machine. The virtual machine is migrated from the first physical machine to a second physical machine when the first physical machine is deemed overloaded. The transmission interface of the virtual machine is migrated from the first I/O unit to a second I/O unit when the first I/O unit is deemed overloaded.

### FIELD

The subject matter herein generally relates to data processing technologies.

### BACKGROUND

Virtualization technology is been used to convert physical resources of a physical machine into a plurality of virtual machines (hereinafter, VMs) that share physical resources. Such physical resources may comprise, for example, a central processing unit (CPU), a memory, a storage, and a network. When a network system provides a plurality of physical machines and each of them runs at least one VM, some VMs may be migrated from one physical machine to another for making full use of all physical resources and enabling stable running in all the VMs. For example, VM1 may be migrated to a suitable physical machine from an original machine (e.g., to P1 from P0) when the original physical machine P0 hosting the VM1 is failed or overloaded.

However, migrating the VM1 from P0 to P1 may waste an amount of physical resources, because the VM cross-migration requires a huge amount of data to be synchronized and migrated.

### BRIEF DESCRIPTION OF THE DRAWINGS

Implementations of the present technology will now be described, by way of example only, with reference to the attached figures, wherein:

FIG. 1 is a block diagram of an exemplary embodiment of a VM migration system;

FIG. 2 is a diagram of an exemplary embodiment of the migration of a VM when a physical machine running the VM is overloaded;

FIG. 3 is a diagram of an exemplary embodiment of the migration of the VM when an input/output (I/O) unit configured as a transmission interface of the VM is overloaded;

FIG. 4 is a diagram of an exemplary embodiment of the migration of the VM when both the physical machine and the I/O unit are overloaded; and

FIG. 5 is a flowchart of a method for migrating a VM.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of an exemplary embodiment described herein. However, it will be understood by those of ordinary skill in the art an exemplary embodiments described herein can be practiced without these specific details. In other instances, methods, procedures, and components have not been described in detail so as not to obscure the related relevant feature being described. Also, the description is not to be considered as limiting the scope of an exemplary embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

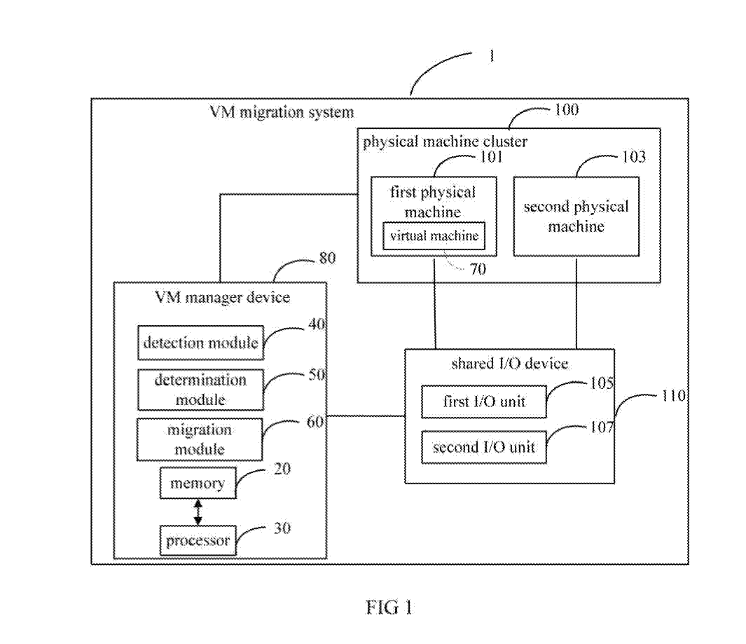

FIG. 1 illustrates an exemplary embodiment of a VM migration system 1. The VM migration system 1 comprises a VM manager device 80, a shared I/O device 110, and a physical machine cluster 100. The VM manager device 80 connects with the shared I/O device 110 and the physical machine cluster 100. The physical machine cluster 100 comprises multiple physical machines (e.g., a first physical machine 101, a second physical machine 103), which may runs a plurality of VMs. In the exemplary embodiment, the first physical machine runs a VM 70. The shared I/O device 110 comprises multiple I/O units (e.g., a first I/O unit 105, a second I/O unit 107) and is connected to each of the multiple physical machines through the multiple I/O units. In the exemplary embodiment, one of the multiple I/O units (e.g., the first I/O unit 105) may be configured as a transmission interface of the VM 70. The VM migration device 80 controls and manages the establishment, revocation, and migration of the VM 70.

In an exemplary embodiment, the VM migration device 80 may be an external device connected to the physical machine or the shared I/O device 110, or may be an independent electronic device.

Referring to FIG. 1, in the exemplary embodiment, the VM migration device 80 comprises a memory 20, a processor 30, a detection module 40, a determination module 50, and a migration module 60. The modules 40-60 can be executed by one or more processors (for example the processor 30) to achieve functionality. The memory 20 can store code and data of the device 80.

The detection module 40 detects a first usage status of the first physical machine 101 and a second usage status of the first I/O unit 105. The first usage status of the first physical machine 101 includes a first utilization rate of a CPU or a second utilization rate of a storage unit. The second usage status of the first I/O unit 105 includes a third utilization rate of a transmission bandwidth.

The determination module 50 determines whether the first physical machine 101 is overloaded based on a comparison between the first utilization rate and a first preset threshold value or between the second utilization rate and the first preset threshold value. It is determined that the first physical machine 101 is overloaded when the first utilization rate or the second utilization rate is greater than the first preset threshold value. In the exemplary embodiment, “90%” may be set as the first preset threshold value, thus it is determined that the first physical machine 101 is overloaded when the first utilization rate or the second utilization rate is greater than 90%. In another exemplary embodiment, different preset threshold values may be set for the first utilization rate and the second utilization rate.

If it is determined that the first physical machine 101 is not overloaded based on the comparison, that is, that neither the first utilization rate nor the second utilization rate is greater than the first preset threshold value, the determination module 50 monitors whether the first I/O unit 105 is overloaded by comparing the third utilization rate with a second preset threshold. It is determined that the first I/O unit 105 is overloaded if the third utilization rate is greater than the second threshold value. In the exemplary embodiment, “95%” may be set as the second preset threshold value, that is, the first I/O unit 105 is determined as overloaded when the third utilization rate is greater than 95%.

In another exemplary embodiment, the second usage status of the first I/O unit 105 may be a transmission speed. The determination module 50 determines whether the first I/O unit is overloaded by comparing the transmission speed with the second preset threshold value. For example, “100 Mbit/S” may be set as the second preset threshold value, and the first I/O unit 105 is determined as overloaded when the transmission speed is greater than 100 Mbit/S.

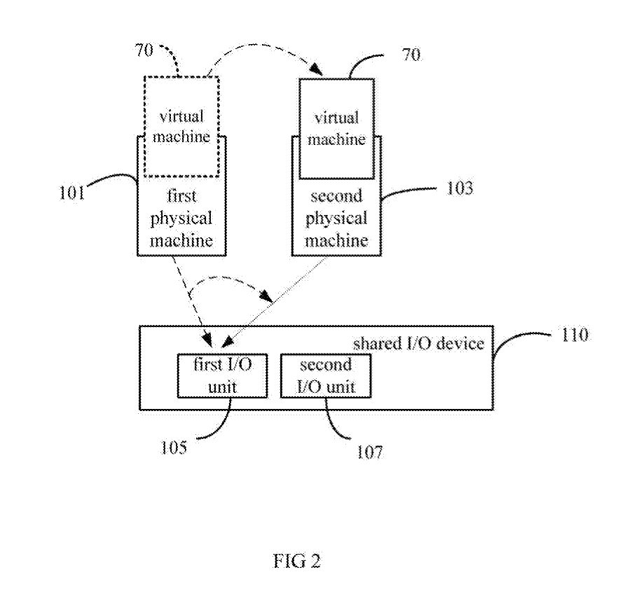

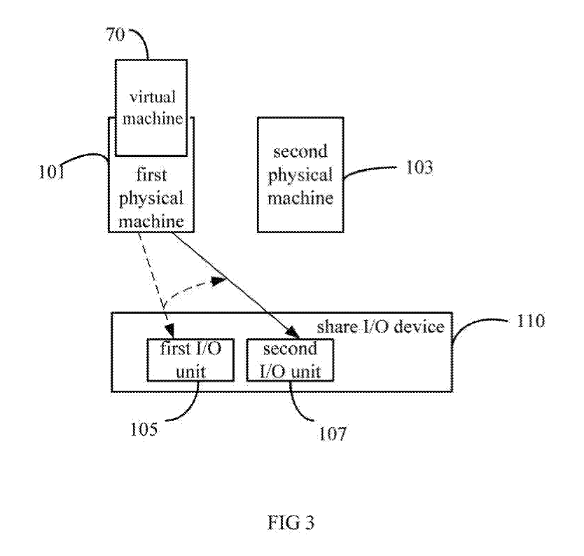

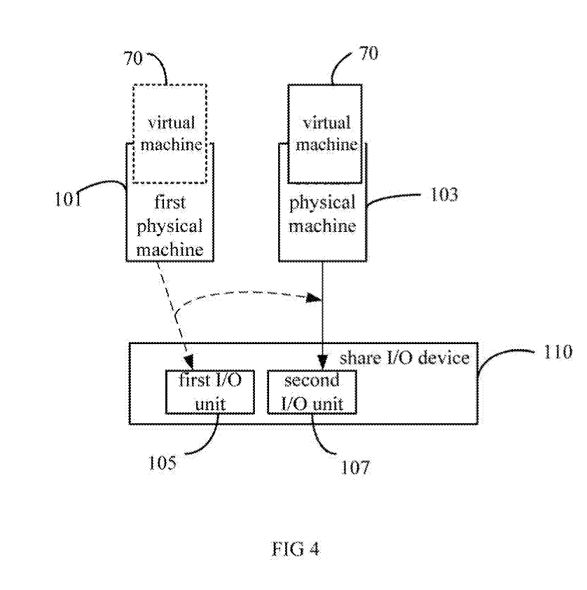

The migration module 60 performs a migration operation according to determinations by the determination module 50. Referring to FIG. 2, the migration module 60 migrates the VM 70 from the first physical machine 101 to the second physical machine 103 when it is determined that the first physical machine 101 is overloaded but the first I/O unit 105 is not. Referring to FIG. 3, the migration module 60 migrates the transmission interface of the VM 70 from the first I/O unit 105 to the second I/O unit 107 when it is determined that the first I/O unit 105 is overloaded but the first physical machine 101 is not. Referring to FIG. 4, the migration module 60 migrates the VM 70 from the first physical machine 101 to the second physical machine 103 and migrates the transmission interface of the VM 70 from the first I/O unit 105 to the second I/O unit 107 when it is determined that both the first physical machine 101 and the first I/O unit 105 are overloaded.

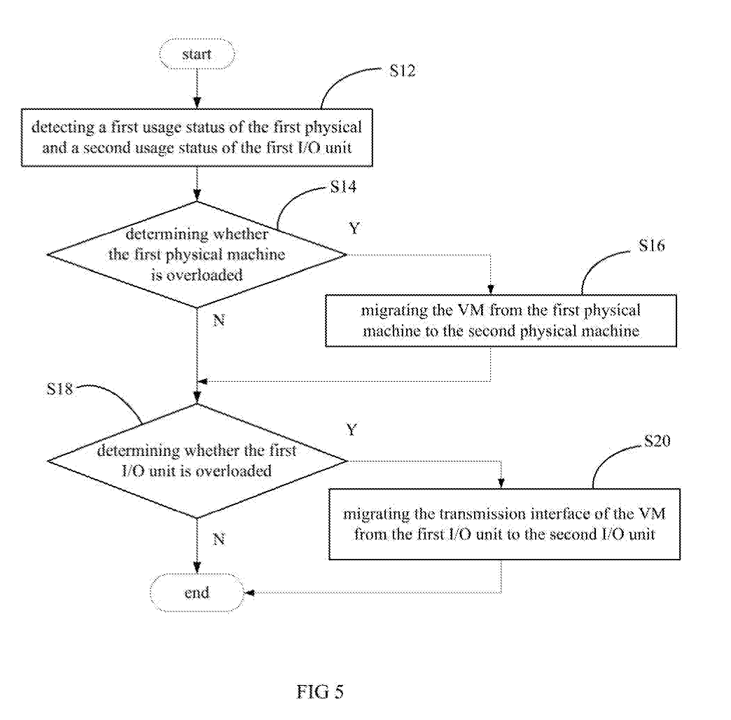

FIG. 5 is a flowchart of a method for migrating a VM. The method may be executed in a system which comprises a physical machine cluster and a shared I/O device. The physical machine cluster comprises a first physical machine and a second physical machine, and the shared I/O device comprises a first I/O unit and a second I/O unit.

At block 12, a first usage status of the first physical machine and a second usage status of the first I/O unit are detected. The first physical machine runs the VM, and the first I/O unit is configured as a current transmission interface of the VM. The first usage status of the first physical machine includes a first utilization rate of a CPU and a second utilization rate of a storage unit. The second usage status of the first I/O unit includes a third utilization rate, that is, a transmission bandwidth. In an exemplary embodiment, the second usage status of the first I/O unit may be a transmission speed.

At block 14, whether or not the first physical machine is overloaded is determined according to the first usage status. In this exemplary embodiment, whether the first physical machine is overloaded is determined by separately comparing the first utilization rate and the second utilization rate with a first preset threshold value. The first physical machine being overloaded is determined when the first utilization rate or the second utilization rate is greater than the first preset threshold value. In this exemplary embodiment, “90%” may be set as the first preset threshold value, the first physical machine 101 being deemed overloaded when the first utilization rate or the second utilization rate is greater than 90%. In another exemplary embodiment, different preset threshold values are set for the first utilization rate and the second utilization rate.

At block 16, the VM is migrated from the first physical machine to the second physical machine when an overloading of the first physical machine is determined.

At block 18, whether or not the first I/O unit is overloaded is determined according to the second usage status. In this exemplary embodiment, whether the first I/O unit being overloaded is determined by comparing the third utilization rate with a second preset threshold. The first I/O unit is deemed overloaded when the third utilization rate is greater than the second threshold value. In this exemplary embodiment, “95%” may be set as the second preset threshold value, that is, the first I/O unit 105 is determined as overloaded when the third utilization rate is greater than 95%.

In another exemplary embodiment, the second usage status of the first I/O unit may be a transmission speed. An overloading of the first I/O unit is determined by comparing the transmission speed with the second preset threshold value. For example, “100 Mbit/S” may be set as the second preset threshold value, and the first I/O unit is determined as overloaded is determined when the transmission speed is greater than 100 Mbit/S.

At block 20, the transmission interface of the VM is migrated from the first I/O unit to the second I/O unit when an overloading of the first I/O unit is determined.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included within the scope of this disclosure and protected by the following claims.

What is claimed is:

1. A device for migrating a virtual machine running in a first physical machine, the device comprising:
at least one processor;
a non-transitory storage system coupled to at least the one processor and configured to store one or more programs that are to be executed by the at least one processor, the one or more programs comprises instructions for:
detecting a first usage status of the first physical machine;
detecting a second usage status of a first input/output (I/O) unit being configured as a transmission interface of the virtual machine.
determining whether the first physical machine is overloaded according to the first usage status and determining whether the first I/O unit is overloaded according to the second usage status;
when the first physical machine is overloaded, migrating the virtual machine from the first physical machine to a second physical machine; and
when the first I/O unit is overloaded and the first physical machine is not overloaded, migrating the transmission interface of the virtual machine from the first I/O unit to a second I/O unit.

2. The device of claim 1, wherein the first usage status comprises a first utilization rate of a central processing unit (CPU) or a second utilization rate of a storage unit.

3. The device of claim 2, wherein the instruction for determining whether the first physical machine is overloaded further comprises:
determining that the first physical machine is overloaded when the first utilization rate or the second utilization rate is greater than a first preset threshold value.

4. The device of claim 1, wherein the second usage status comprises a third utilization rate of a transmission bandwidth or a transmission speed.

5. The device of claim 1, wherein the instruction for determining whether the I/O unit is overloaded further comprises:
determining that the first I/O unit is overloaded when the third utilization rate or the transmission speed is greater than a second preset threshold value.

6. A method for migrating a virtual machine running in a first physical machine, the method comprising:
detecting a first usage status of the first physical machine;
detecting a second usage status of a first input/output (I/O) unit being configured as a transmission interface of the virtual machine;
determining whether the first physical machine is overloaded according to the first usage status and determining whether the first I/O unit is overloaded according to the second usage status;
when the first physical machine is overloaded, migrating the virtual machine from the first physical machine to a second physical machine; and
when the first I/O unit is overloaded and the first physical machine is not overloaded, migrating the transmission interface of the virtual machine from the first I/O unit to a second I/O unit.

7. The method of claim 6, wherein the first usage status comprises a first utilization rate of a central processing unit (CPU) or a second utilization rate of a storage unit.

8. The method of claim 7, wherein the step of determining whether the first physical machine is overloaded further comprises:
determining that the first physical machine is overloaded when the first utilization rate or the second utilization rate is greater than a first preset threshold value.

9. The method of claim 6, wherein the second usage status comprises a third utilization rate of a transmission bandwidth or a transmission speed.

10. The method of claim 9, wherein the step of determining whether the first I/O unit is overloaded further comprises:
determining that the first I/O unit is overloaded when the third utilization rate or the transmission speed is greater than a second preset threshold value.
